(19) United States
(12) Patent Application Publication
(10) Pub. No.: US 2003/0137525 A1
(43) Pub. Date: Jul. 24, 2003

(54) Method and apparatus for facilitating motion-coupled magnification

(76) Inventor: Randall B. Smith, Palo Alto, CA (US)

Correspondence Address: PARK, VAUGHAN & FLEMING LLP, 508 SECOND STREET, SUITE 201, DAVIS, CA, 95616, US

(21) Appl. No.: 10/056,691

(22) Filed: Jan. 24, 2002

(51) Int. Cl. G09G 5/00

(52) U.S. Cl. 345/671

(57) ABSTRACT

One embodiment of the present invention provides a system that facilitates magnification of a target region within a field of view through use of a magnifier, wherein a magnification level of the magnifier is coupled to motion of the magnifier. Upon receiving a movement command from a user to move the magnifier within the field of view, the system reduces the magnification factor of the magnifier. This makes a larger region of the field of view visible within the magnifier, and thereby facilitates moving the magnifier to a desired location within the field of view. Upon receiving a cessation of movement command from the user indicating that movement of the magnifier has ceased, the system restores the magnification factor of the magnifier to an original magnification factor.

### BACKGROUND

1. Field of the Invention

The present invention relates to magnification systems. More particularly, the present invention relates to a method and an apparatus for facilitating magnification of a target region through use of a magnifier, wherein the level of magnification is coupled to motion of the magnifier.

2. Related Art

As the processing power and the data storage capacity of computer systems both continue to increase at an exponential rate, it is becoming progressively easier to store and to manipulate large data sets within a computer system. However, it can be a challenge to scan through and view such large data sets in an efficient manner because of the limited space that is available on a typical computer display.

A standard viewing technique is to provide one or two-dimensional scrolling. However, it can be quite challenging to locate a specific object in such scrolling systems because only a small portion of the display space is visible at any given time.

This problem can be remedied by using a “context map,” which displays a large portion of the display space at a lower resolution, along with a “magnified view,” which displays a smaller portion of the display space at a higher resolution. This context map allows a user to navigate the magnified view to specific regions within the display space. Unfortunately, since the context map is typically off to one side of the display, the user must avert her gaze from the magnified view in order to determine the position of the magnified view within the context map. Furthermore, the context map consumes valuable screen real estate, leaving less space for the magnified view.

A number of researchers have investigated distortion-oriented displays, such as using a fish eye lens, to view and scan through data in one or more dimensions. A distortion-oriented display can cause severe distortion around the edges of the display, so the context cannot be easily interpreted. This can make it difficult or unnatural to track a target within a distortion-oriented display.

One way to remedy this navigation problem is to present the magnified view as a simulated magnifying lens that can be moved around within a lower-resolution map of the display space. In this way, a target region of the display space can be viewed in magnified form by simply moving the simulated magnifying lens over the target region. Note that in a simulated magnifying lens, an area outside the lens remains undistorted.

However, when a user moves the lens over the target region, a portion of the display space immediately surrounding the magnified target region is not visible. For example, with a circular lens, there is a ring-shaped region beneath the lens, surrounding the magnified zone, which is neither visible within the lens, nor in the rest of the display. This can make it difficult to navigate a lens toward a target region, especially if the lens provides a higher power of magnification.

What is needed is a method and an apparatus that facilitates navigation of a simulated magnifying lens to cover a target region within a display.

### SUMMARY

One embodiment of the present invention provides a system that facilitates magnification of a target region through use of a magnifier, wherein the magnification level of the magnifier is coupled to motion of the magnifier. Upon receiving a movement command from a user to move the magnifier, the system reduces the magnification factor of the magnifier. This makes a larger region of the field of view visible within the magnifier, and thereby facilitates moving the magnifier to a desired location within the field of view.

In a variation on this embodiment, upon receiving a cessation of movement command from the user indicating that movement of the magnifier has ceased, the system restores the magnification factor of the magnifier to an original magnification factor.

In a variation on this embodiment, the movement command is a mouse drag event, and the cessation of movement command is a mouse button up event.

In a variation on this embodiment, when the magnification factor is reduced, the system visually indicates a boundary of a magnified region within the magnifier. This magnified region becomes visible in magnified form when the magnification factor is restored to an original magnification factor.

In a further variation, visually indicating the boundary of the magnified region involves modifying the appearance of regions within the magnifier that are located outside of the magnified region. This modification can involve grey shading, modifying color or modifying translucence.

In a variation on this embodiment, the system reduces the magnification factor to one so that the magnifier no longer obscures portions of the field of view located under the magnifier.

In a variation on this embodiment, the movement command is a command that selects the magnifier in preparation for moving the magnifier.

In a variation on this embodiment, reducing the magnification factor involves reducing the magnification factor by a factor that is proportionate to a drag speed of the magnifier. In this way, the faster the magnifier is moved, the more the magnification level is reduced. This avoids sudden discontinuities associated with jumping between levels of magnification.

In a variation on this embodiment, the magnifier is a window that the user can move about the field of view.

In a variation on this embodiment, the field of view is a display for a computational device.

### BRIEF DESCRIPTION OF THE FIGURES

FIG. 1 illustrates a computer system with display containing a magnifier in accordance with an embodiment of the present invention.

FIG. 2 is a flow chart illustrating how the magnification level of the magnifier is reduced in response to a movement command in accordance with an embodiment of the present invention.

FIG. 3 is a flow chart illustrating how the magnification level of the magnifier is restored after receiving a cessation of movement command in accordance with an embodiment of the present invention.

FIG. 4 illustrates operation of an exemplary motion-coupled magnifier in accordance with an embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the principles and features disclosed herein.

The data structures and code described in this detailed description are typically stored on a computer readable storage medium, which may be any device or medium that can store code and/or data for use by a computer system. This includes, but is not limited to, magnetic and optical storage devices such as disk drives, magnetic tape, CDs (compact discs) and DVDs (digital versatile discs or digital video discs), and computer instruction signals embodied in a transmission medium (with or without a carrier wave upon which the signals are modulated). For example, the transmission medium may include a communications network, such as the Internet.

Computer System

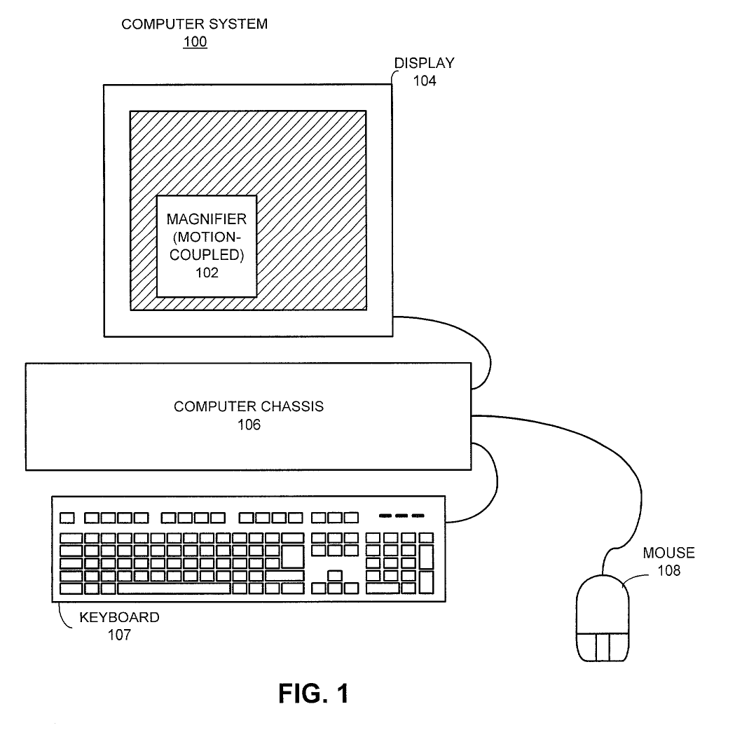

FIG. 1 illustrates a computer system 100 including a display 104 containing a magnifier 102 in accordance with an embodiment of the present invention. Computer system 100 can generally include any type of computer system, including, but not limited to, a computer system based on a microprocessor, a mainframe computer, a digital signal processor, a portable computing device, a personal organizer, a device controller, and a computational engine within an appliance.

In the embodiment illustrated in FIG. 1, computer system 100 includes a computer chassis 106, which receives input from both a keyboard 107 and a mouse 108. Computer system 100 outputs graphical images to display 104, which includes magnifier 102.

Magnifier 102 magnifies a target region of display 104 that is located under magnifier 102. Moreover, magnifier 102 can be moved around display 104 by entering commands through mouse 108 and/or keyboard 107.

Process of Adjusting Magnification Level in Response to Movement

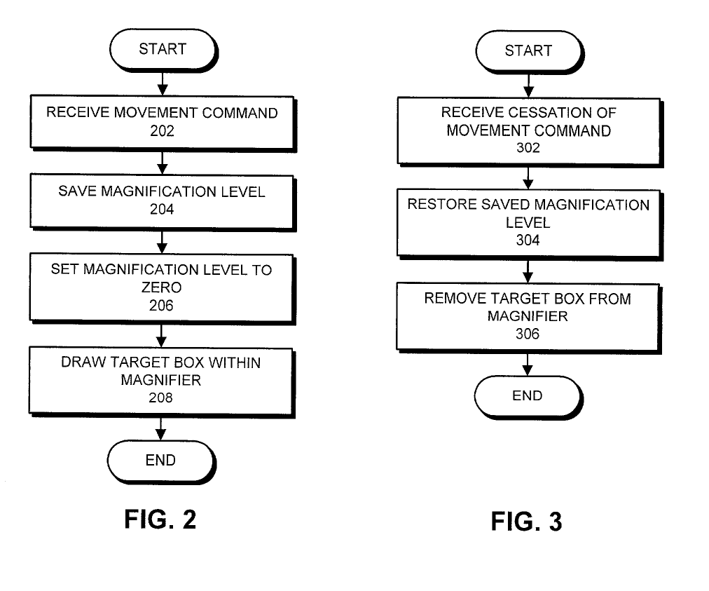

FIG. 2 is a flow chart illustrating the process of reducing the magnification level of magnifier 102 in response to a movement command in accordance with an embodiment of the present invention. Upon receiving a movement command (step 202), the system performs a number of operations. The system first saves the original magnification factor of magnifier 102 (step 204). Next, the system sets the magnification factor of magnifier 102 to one (step 206). The system also draws a target box within magnifier 102 (step 208). This target box delineates a region within magnifier 102 that remains visible within magnifier 102 when the original magnification factor is restored. This makes a larger region of the display visible within magnifier 102, and thereby makes it user for a user to navigate magnifier 102 into a position where it magnifies a desired region within display 104.

Note that the movement command can generally be any type of user-initiated event or command associated with moving magnifier 102. For example, the movement command can include a “mouse drag” event that is triggered when the mouse is moved at the same time a mouse button is depressed. The movement command can also include a command that selects the magnifier in preparation for moving the magnifier, such as a “mouse enter” or “mouse down” command. Other events can trigger demagnification, such as movement of a cursor into the magnifier.

Note that the target box within the magnifier is generally in the shape of magnifier 102, which is not necessarily box-shaped. Furthermore, the size of the target box can be determined by dividing the magnifier size by the magnification factor of the magnifier.

In one embodiment of the present invention, the region within the target box is clear, and surrounding regions within the magnifier are modified by grey shading, modifying color or modifying translucence. In this way, no lines are required to delineate the border of the magnifier or the target box. In another embodiment, the target region is modified and surrounding regions are clear.

In one embodiment of the present invention, the magnification factor is reduced by a factor that is proportionate to a drag speed of the magnifier. In this way, the onset of magnification is gradual. Furthermore, the faster the magnifier is moved, the more the magnification factor is reduced.

Process of Restoring Magnification Level

FIG. 3 is a flow chart illustrating how the magnification level of the magnifier is restored. Upon receiving a cessation of movement command (step 302), the system restores the saved magnification factor for magnifier 102 (step 304). The system also removes the target box from magnifier 102 (step 306).

This cessation of movement command can generally include any command or event that indicates that movement of magnifier 102 has ceased. For example, the cessation of movement command can include a “mouse up” command or, alternatively, the absence of a movement condition.

Exemplary Operation

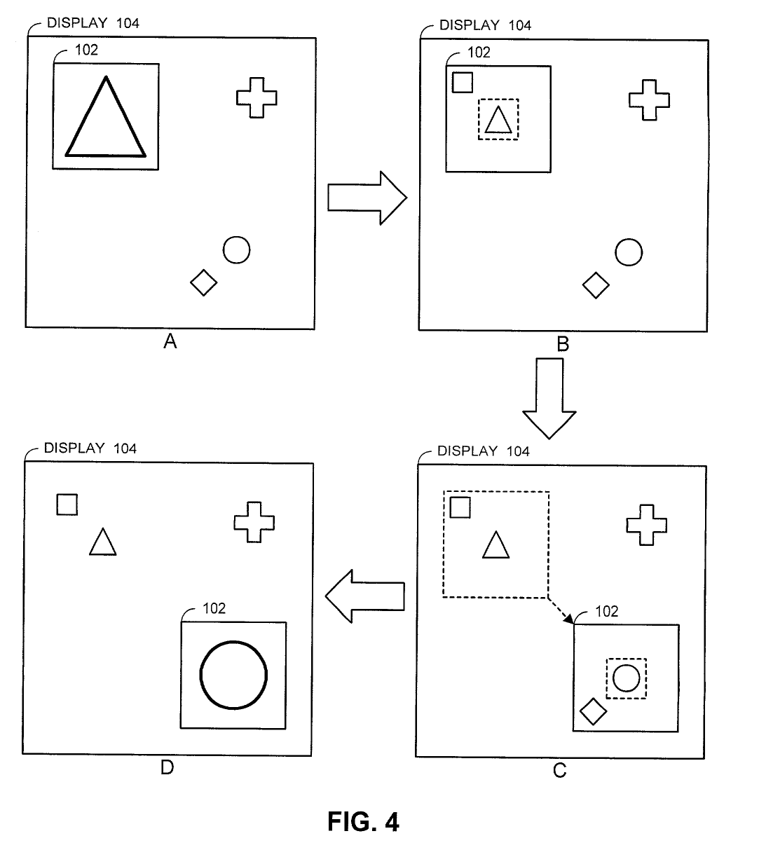

FIG. 4 illustrates operation of an exemplary motion-coupled magnifier in accordance with an embodiment of the present invention. The example starts with the instance of display 104 labeled “A” in the upper left-hand corner of FIG. 4. In this instance, the display includes a magnifier 102, which magnifies a triangle.

Next, when a user begins to drag magnifier 102, using a mouse or other pointing device, the system reduces the magnification factor of magnifier 102 to one as is illustrated in the instance of display 104 labeled “B”. Note that when the magnification level is reduced, a square that was previously obscured by magnifier 102 becomes visible within magnifier 102. Also note that a “target box” is added to magnifier 102, as is illustrated by the dashed lines within magnifier 102. This target box delineates the boundaries of a region within magnifier 102 that becomes visible in magnified form when the magnification level is restored.

Next, the user drags magnifier 102 to another location within display 104, as is illustrated in the instance of display 104 labeled “C”. In this location, the target box surrounds a circle within display 104.

When the drag operation is complete, the magnification level is restored, as is illustrated in the instance of display 104 labeled “D”. This causes the circle to be magnified. Furthermore, note that the target box no longer appears within magnifier 102.

Many other variations of the above-described process are possible. For example, in one embodiment of the present invention, moving the cursor to a location in display 104 and selecting the location causes the magnifier to appear over the location.

The foregoing descriptions of embodiments of the present invention have been presented only for purposes of illustration and description. They are not intended to be exhaustive or to limit the present invention to the forms disclosed. Accordingly, many modifications and variations will be apparent to practitioners skilled in the art. For example, the present invention is not limited to computer-based magnification systems. The present invention generally applies to any magnification system, including optical magnification systems that use mechanical components to facilitate motion-coupled magnification.

Additionally, the above disclosure is not intended to limit the present invention. The scope of the present invention is defined by the appended claims.

What is claimed is:

1. A method for facilitating magnification of a target region within a field of view through use of a magnifier, wherein a magnification level of the magnifier is coupled to motion of the magnifier, the method comprising:
receiving a movement command from a user to move a location of the magnifier within the field of view; and
in response to the movement command, reducing the magnification factor of the magnifier, so that a larger portion of the field of view becomes visible within the magnifier to facilitate navigating the magnifier to a desired location.

2. The method of claim 1, further comprising:
receiving a cessation of movement command from the user indicating that movement of the magnifier has ceased; and
in response to the cessation of movement command, restoring the magnification factor of the magnifier to an original magnification factor.

3. The method of claim 2, wherein the movement command is a mouse drag event and the cessation of movement command is a mouse button up event.

4. The method of claim 1, wherein when the magnification factor is reduced, the method further comprises visually indicating a boundary of a magnified region within the magnifier, wherein the magnified region becomes visible in magnified form when the magnification factor is restored to an original magnification factor.

5. The method of claim 4, wherein visually indicating the boundary of the magnified region involves modifying the appearance of regions within the magnifier that are located outside of the magnified region, wherein the modification involves grey shading, modifying color or modifying translucence.

6. The method of claim 1, wherein reducing the magnification factor involves reducing the magnification factor to one so that the magnifier no longer obscures portions of the field of view located under the magnifier.

7. The method of claim 1, wherein the movement command is a command that selects the magnifier in preparation for moving the magnifier.

8. The method of claim 1, wherein reducing the magnification factor involves reducing the magnification factor by a factor that is proportionate to a drag speed of the magnifier, whereby the faster the magnifier is moved, the more the magnification level is reduced.

9. The method of claim 1, wherein the magnifier is a window that the user can move about the field of view.

10. The method of claim 1, wherein the field of view is a display for a computational device.

11. A computer-readable storage medium storing instructions that when executed by a computer cause the computer to perform a method for facilitating magnification of a target region through use of a magnifier, wherein a magnification level of the magnifier is coupled to motion of the magnifier within a field of view, the method comprising:
receiving a movement command from a user to move a location of the magnifier within the field of view; and
in response to the movement command, reducing the magnification factor of the magnifier, so that a larger portion of the field of view becomes visible within the magnifier to facilitate navigating the magnifier to a desired location within the field of view.

12. The computer-readable storage medium of claim 11, wherein the method further comprises:
receiving a cessation of movement command from the user indicating that movement of the magnifier has ceased; and
in response to the cessation of movement command, restoring the magnification factor of the magnifier to an original magnification factor.

13. The computer-readable storage medium of claim 12, wherein the movement command is a mouse drag event and the cessation of movement command is a mouse button up event.

14. The computer-readable storage medium of claim 11, wherein when the magnification factor is reduced, the method further comprises visually indicating a boundary of a magnified region within the magnifier, wherein the magnified region becomes visible in magnified form when the magnification factor is restored to an original magnification factor.

15. The computer-readable storage medium of claim 14, wherein visually indicating the boundary of the magnified region involves modifying the appearance of regions within the magnifier that are located outside of the magnified region, wherein the modification involves grey shading, modifying color or modifying translucence.

16. The computer-readable storage medium of claim 11, wherein reducing the magnification factor involves reducing the magnification factor to one so that the magnifier no longer obscures portions of the field of view located under the magnifier.

17. The computer-readable storage medium of claim 11, wherein the movement command is a command that selects the magnifier in preparation for moving the magnifier.

18. The computer-readable storage medium of claim 11, wherein reducing the magnification factor involves reducing the magnification factor by a factor that is proportionate to a drag speed of the magnifier, whereby the faster the magnifier is moved, the more the magnification level is reduced.

19. The computer-readable storage medium of claim 11, wherein the magnifier is a window that the user can move about the field of view.

20. The computer-readable storage medium of claim 11, wherein the field of view is a display for a computational device.

21. An apparatus that facilitates magnification of a target region within a display, comprising:
a computational device;
the display within the computational device;
a magnifier within the display;
a user interface that is configured to receive a movement command from a user to move a location of the magnifier within the display; and
wherein in response to the movement command, the magnifier is configured to reduce a magnification factor associated with the magnifier, so that a larger portion of the display becomes visible within the magnifier to facilitate navigating the magnifier to a desired location within the display.

22. The apparatus of claim 21,
wherein the user interface is additionally configured to receive a cessation of movement command from the user indicating that movement of the magnifier has ceased; and
wherein in response to the cessation of movement command, the magnifier is configured to restore the magnification factor to an original magnification factor.

23. The apparatus of claim 22, wherein the movement command is a mouse drag event and the cessation of movement command is a mouse button up event.

24. The apparatus of claim 21, wherein when the magnification factor is reduced, the magnifier is configured to visually indicate a boundary of a magnified region within the magnifier, wherein the magnified region becomes visible in magnified form when the magnification factor is restored to an original magnification factor.

25. The apparatus of claim 24, wherein while visually indicating the boundary of the magnified region, the magnifier is configured to modify the appearance of regions within the magnifier that are located outside of the magnified region, wherein the modification involves grey shading, modifying color or modifying translucence.

26. The apparatus of claim 21, wherein the magnifier is configured to reduce the magnification factor to one, so that the magnifier no longer obscures portions of the display located under the magnifier.

27. The apparatus of claim 21, wherein the movement command is a command that selects the magnifier in preparation for moving the magnifier.

28. The apparatus of claim 21, wherein the magnifier is configured to the magnification factor by a factor that is proportionate to a drag speed of the magnifier, whereby the faster the magnifier is moved, the more the magnification level is reduced.

29. The apparatus of claim 21, wherein the magnifier is a window that the user can move about the display.
